(19) United States
(12) Patent Application Publication
(10) Pub. No.: US 2013/0129110 A1
(43) Pub. Date: May 23, 2013

(54) Headphone System for Activating a Control Module

(71) Applicant: KADDAN ENTERTAINMENT, INC., New York, NY (US)

(72) Inventor: Patrick Sean HARPER, New York, NY (US)

(73) Assignee: KADDAN ENTERTAINMENT, INC., New York, NY (US)

(21) Appl. No.: 13/680,166

(22) Filed: Nov. 19, 2012

Related U.S. Application Data
(60) Provisional application No. 61/561,563, filed on Nov. 18, 2011.

(51) Int. Cl. H04R 1/10

(52) U.S. Cl. CPC H04R 1/1041
USPC 381/74

(57) ABSTRACT

A system for remotely controlling an audio device or the audio emitted by a pair of headphones/earbuds through the coupling of coupling devices (with each other and/or with a coupling base), which may be part of the headphones/earbuds, respectively. The coupling of the headphones may effectively create a switch, which is connected to the input of a remote control module. The remote control module may send a specific signal to the audio device through a pin on the headphone plug (which may be received by a headphone jack on the device though a multi-pin cable interface). This signal may be determined by a control module activated via the completion of a circuit through the temporary coupling of the two earbuds/headphones. The audio device, to which the plug is connected via a headphone jack, may perform various actions based on the signal emitted via a pin on the headphone ring.

### CROSS-REFERENCE TO RELATED APPLICATIONS

The present application claims the benefit of priority to U.S. Provisional Application Ser. No. 61/561,563, filed on Nov. 18, 2011, the entire disclosure of which is incorporated herein by reference.

### BACKGROUND

1. Field of Invention

The present invention relates generally to remote control of an audio device or audio emission by a pair of headphones/earbuds. More particularly, the present invention relates to the remote control of an audio device or audio emission by a pair of headphones/earbuds through the coupling of coupling devices with each other (and/or through the coupling of one or more coupling devices with a coupling base).

2. Discussion of the Background

The use of portable audio and video devices, including smartphones, has grown rapidly as a way for people to listen to various audio mediums while on the go. These devices require some sort of audio transducer/headphone to convert the electrical signals from the portable device into audible sound. Many designs of these “headphones” exist, but headphones that can remotely control the audio device to which they are connected are increasingly popular. The remote control is generally connected to the headphone wire and has one or multiple buttons used to control the audio device.

These remote controls typically enable the user to play, pause, skip forward or skip backward the tracks on the audio device. Additionally, if the audio device is a smartphone, the remote control may allow the user to answer and end incoming phone calls.

While these devices provide a convenient solution to controlling an audio player when in use, they do not address the ease of control when a user wishes to stop or start using his or her headphones. When a user wishes to stop using the headphones, the user must press the button to pause the remote and then remove the earbuds/headphones from the user's ears, a two-step process.

Additionally, certain headphones are designed to be connected via a coupling device so that the user may wear the headphones around the neck when they are not in use. Such systems are described, for example, in U.S. Pat. Nos. 7,436,974; 7,693,295; and 8,189,843, which are hereby incorporated by reference in their entireties. Other headphone systems may have a remote control integrated with them, and require the user to pause the remote, remove the earbuds/headphones from the user's ears, and connect them behind the neck, a three-step process. While such systems can provide a means of temporarily discontinuing listening to audio, they require multiple steps to achieve the desired result.

FIG. 1 illustrates the exterior of an example of a conventional earbud headphone system, including a remote control 107 and right and left coupling devices 110 and 111. The conventional earbud headphone system includes a right transducer 101 and left transducer 102 that can be inserted directly in the ears of a user. The right transducer 101 has a right mechanical housing 103, and the left transducer 102 has a left mechanical housing 104. A right wire 105 and a left wire 106 are connected to the right and left mechanical housings 103 and 104, respectively, of the transducers 101 and 102. The other ends of the right and left wires 105 and 106 come together to form a combined wire 108 that is attached to an audio plug 109. One of the right and left wires 105 and 106 coming out of the mechanical housing, in this example the right wire 105, is connected to a remote control 107 that includes buttons for controlling an audio device to which the plug 109 is connected. In operation, the right transducer 101 is placed in the user's right ear, the left transducer 102 is placed in the user's left ear, and the user can hear audio supplied by the audio device.

This system further includes a right coupling device 110 and left coupling device 111 that serve to create a temporary connection when coupled together for the purposes of storing the headphones when not in use. This system could further comprise a microphone (not pictured), which may be embedded in the housing of the remote control module 107.

FIGS. 2A and 2B are schematic diagrams illustrating the wiring of the example of the conventional earbud headphone system including a remote control 107. The right transducer 101 is connected to both a ground wire 203 and a right signal wire 204. The left transducer 102 is connected to both the ground wire 203 and a left signal wire 205. The remote control module 107 is connected to both the ground wire 203, via an extension wire 206, and to a control wire 208. Each of the right signal wire 204, the left signal wire 205, the ground wire 203, and the control wire 208 is connected to the audio plug 109. When a signal is sent from a remote control button 210, thereby temporarily completing a circuit, the module (e.g., a multiplexer as shown in FIG. 2B) included in the remote control module 107 sends a signal via the control wire 208, which is received by the audio device to which the plug 109 is connected. The remote control module 107 may further comprise a microphone (not pictured), which may be connected to the control wire 208 and, therefore, to a specific pin on the multi-pin plug 109. The right and left coupling devices 110 and 111 are not illustrated in FIGS. 2A and 2B because the right and left coupling devices 110 and 111 are not connected to the wiring of the conventional earbud headphone system and form no part of the circuit thereof.

There is presently a need in the art for a system or systems to more-easily control the audio player connected to earbuds/headphones or the earbuds/headphones themselves.

### SUMMARY

The present invention overcomes the disadvantages of prior systems by providing, among other advantages, a system that allows for the control of a portable audio or video device through coupling of coupling devices (with each other and/or with a coupling base). In an aspect, the invention provides an earbud/headphone system comprising a first earbud/headphone and a second earbud/headphone and a circuit for remotely controlling a portable audio device, controlling the volume of audio produced by the headphone transducers, and/or muting the audio produced by the headphone transducers, when coupling the earbuds/headphones.

In an embodiment, the circuit may be completed by the physical connection of two open ends of the circuit, one open end being exposed on a portion of the first earbud/headphone and the other open end being exposed on a portion of the second earbud/headphone. In further embodiments, the portion of the first earbud/headphone may be a surface of the first earbud/headphone's housing and/or the portion of the second earbud/headphone is a surface of second earbud/headphone's housing. One or both surfaces may be outer surfaces of the housing or housings. In further embodiments, one or more circuits may be completed via a physical switch or switches. In still further embodiments, the physical switch or switches may be opened or closed by the presence of a magnetic field.

One aspect of the present invention provides a headphone system having a first headphone including a first transducer, a second headphone including a second transducer, a first coupling device, a second coupling device, and circuitry. The circuitry may be configured to remotely control a portable audio device, control the volume of audio produced by the first and second transducers, and/or mute the audio produced by the first and second transducers based on coupling of the first and second coupling devices with each other.

In some embodiments, the first and second coupling devices may be conductive of electricity, and the circuitry may include a circuit that is completed by the physical connection of first and second coupling devices. The first headphone may include a first housing, the second headphone may include a second housing, the conductive first coupling device may be exposed through a surface of the first housing, and the conductive second coupling device may be exposed through a surface of the second housing.

In some embodiments, the first coupling device may include a physical switch, and the circuitry may include a circuit that is completed via the opening or closing of the physical switch. The physical switch may be opened or closed by the presence of a magnetic field. The second coupling device may include a magnet.

In some embodiments, the circuitry may include a circuit that, when completed, effectively shorts another circuit or applies resistance across another circuit. The first headphone may be a first earbud, and the second headphone may be a second earbud. The first headphone may be a right headphone, the second headphone may be a left headphone, the first coupling device may be a right coupling device, and the second coupling device may be a left coupling device. The first headphone may include the first coupling device, and the second headphone includes the second coupling device.

In some embodiments, the circuitry may include a multi-pin audio plug and a ground wire, and first and second signal wires connected to respective pins of the multi-pin audio plug. The circuitry may include (i) a remote control module having one or more buttons and (ii) a control wire connected to the remote control module and a pin of the multi-pin audio plug. The circuitry may include (i) a first sensor wire connected to the remote control module and the first coupling device and (ii) a second sensor wire connected to the second coupling device and the ground wire. The circuitry may include (i) a first sensor wire connected to the remote control module and the first coupling device and (ii) an extension wire connected to the first coupling device and the first signal wire. The ground wire may connected to the first coupling device, and the circuitry may include (i) a first extension wire connected to the first coupling device and the first transducer and (ii) a second extension wire connected to the first extension wire and the second transducer. The first coupling device may include first and second signal wire contacts and insulation separating the first and second signal wire contacts, and the circuitry may include (i) a first signal wire extension connecting the first signal wire and the first signal wire contact, (ii) a second signal wire extension connecting the second signal wire and the second signal wire contact, and (iii) a ground wire extension connecting the second coupling device and the ground wire. The first signal wire extension may include a first resistor, the second signal wire extension may include a second resistor, and the second coupling device may include a magnet.

In some embodiments, the system may include a control module configured to enable a user to remotely control a portable audio device or to change the state of the headphone circuitry, effectively reprogramming it. The coupling of the first and second coupling devices may initiate a process in the control module that activates a switch or applies resistance within a circuit. This process may act to switch between the headphones being muted or unmuted when connected via the coupling of the first and second coupling devices.

In some embodiments, the system may include a control module and a coupling base. Coupling of the first and/or second coupling device to the coupling base may initiate a process in the control module that activates a switch or applies resistance within a circuit.

Another aspect of the present invention provides a headphone system having a first headphone including a first transducer, a second headphone including a second transducer, a first coupling device, a second coupling device, a coupling base, and circuitry. The circuitry may be configured to remotely control a portable audio device, control the volume of audio produced by the first and second transducers, and/or mute the audio produced by the first and second transducers based on a change of potential across one or more wires within the circuit. The change may be caused by contact of the first and/or second coupling devices with the coupling base.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 illustrates the exterior of an example of a conventional earbud headphone system.

FIGS. 2A and 2B are schematic diagrams illustrating the wiring of the example of the conventional earbud headphone system.

FIGS. 3A and 3B are schematic diagrams illustrating an example of a headphone system according to one embodiment of the present invention.

FIGS. 3C and 3D are schematic diagrams illustrating another example of a headphone system according to one embodiment of the present invention.

FIGS. 4A and 4B are schematic diagrams illustrating a further example of a headphone system according to one embodiment of the present invention.

FIG. 5 is a schematic diagram illustrating a further example of a headphone system according to one embodiment of the present invention.

FIG. 6A through 6C illustrate another example of a headphone system according to one embodiment of the present invention.

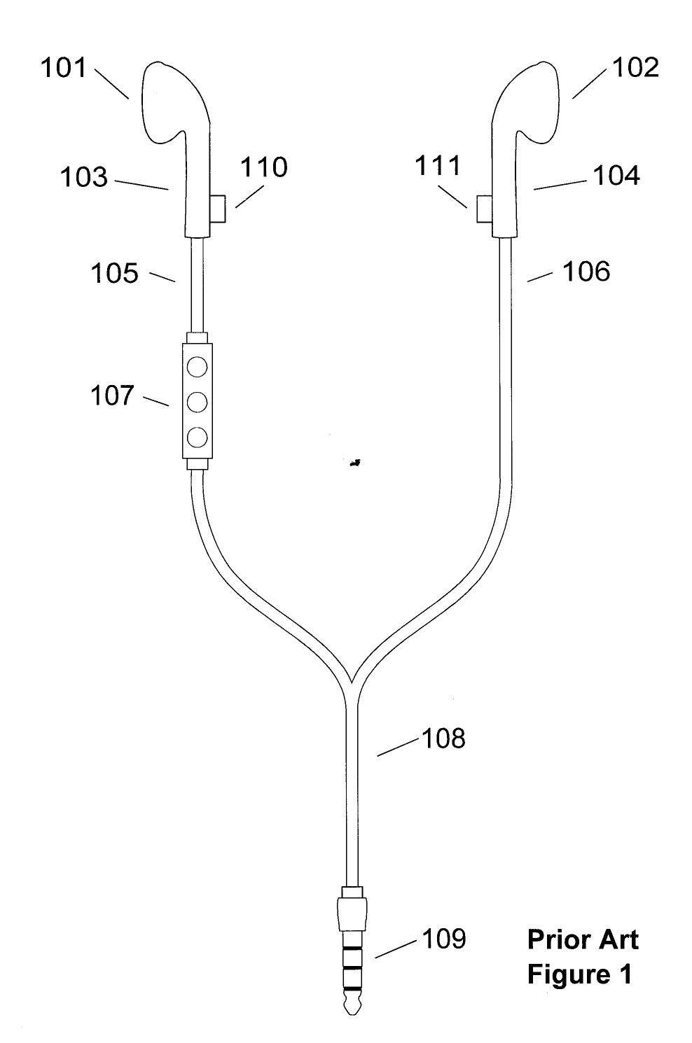

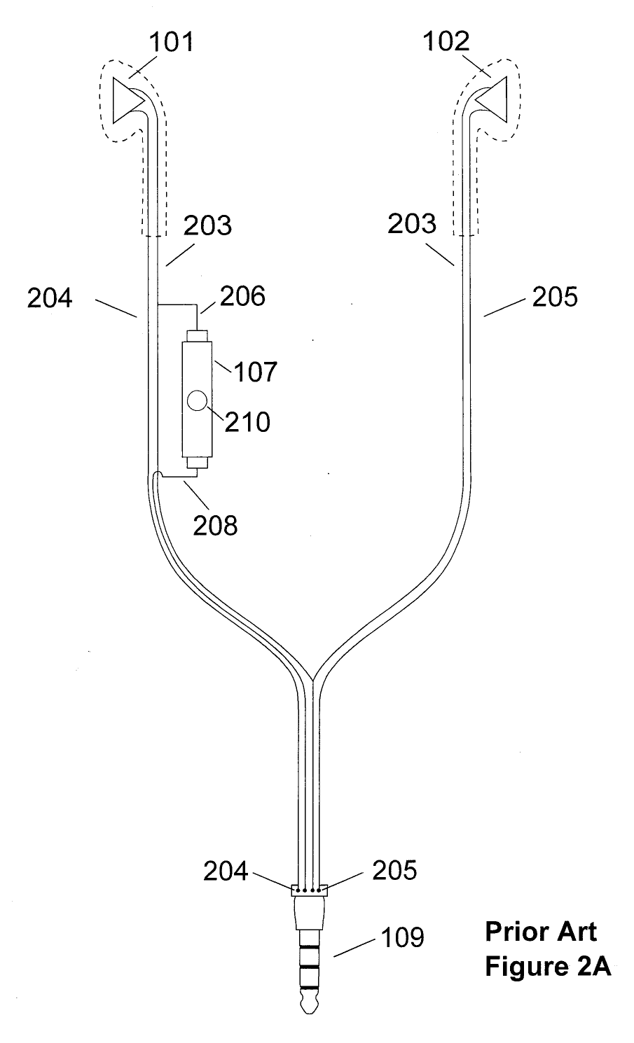

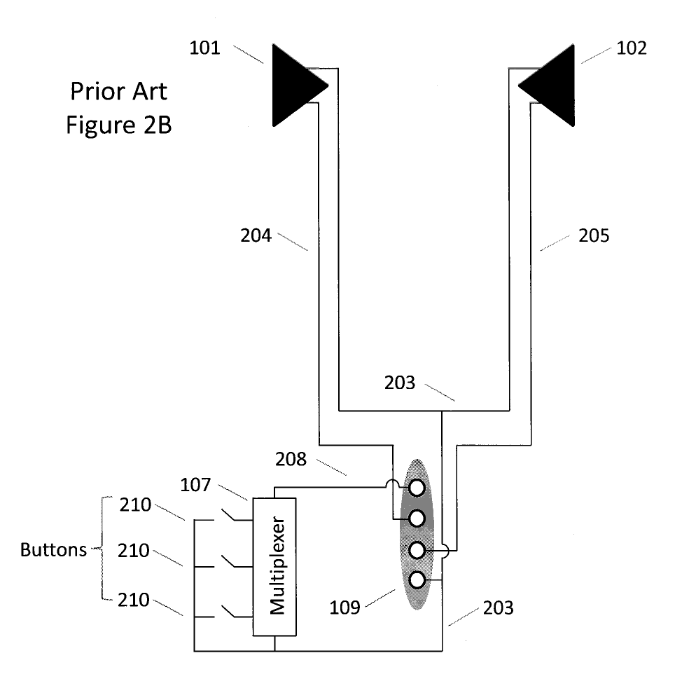

### DETAILED DESCRIPTION OF PREFERRED EMBODIMENTS

The present invention, including but not limited to the embodiments described herein, relates to the remote control of an audio device or audio emission by a pair of headphones based on the coupling of coupling devices.

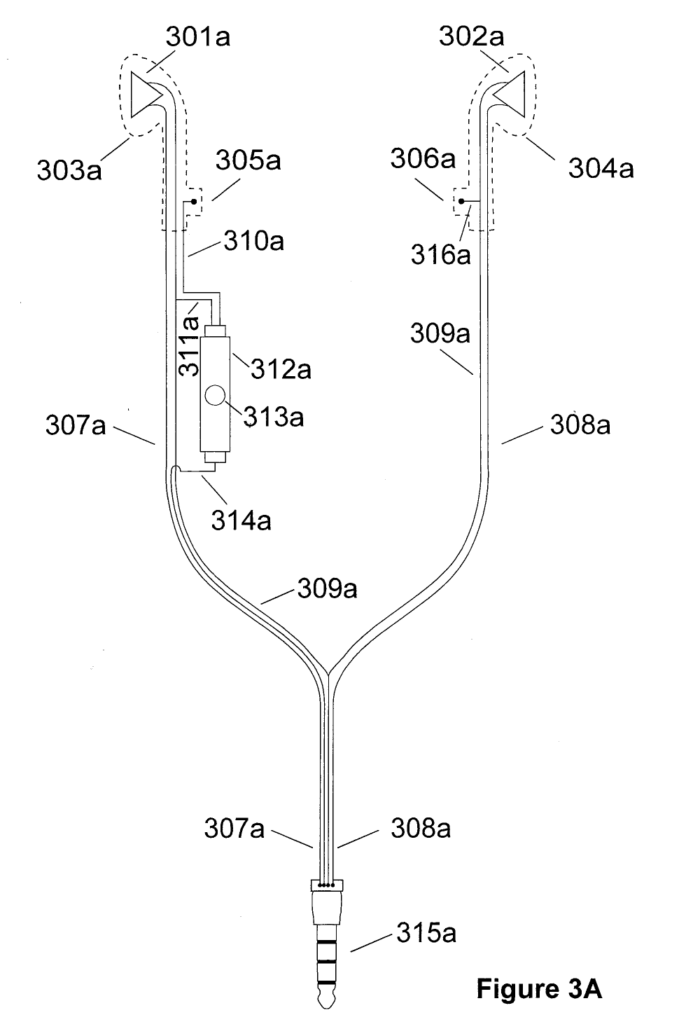

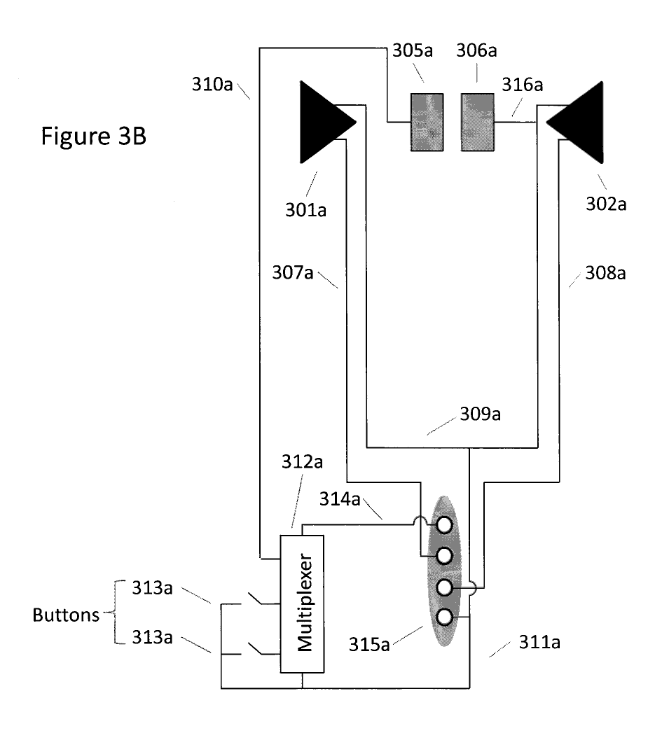

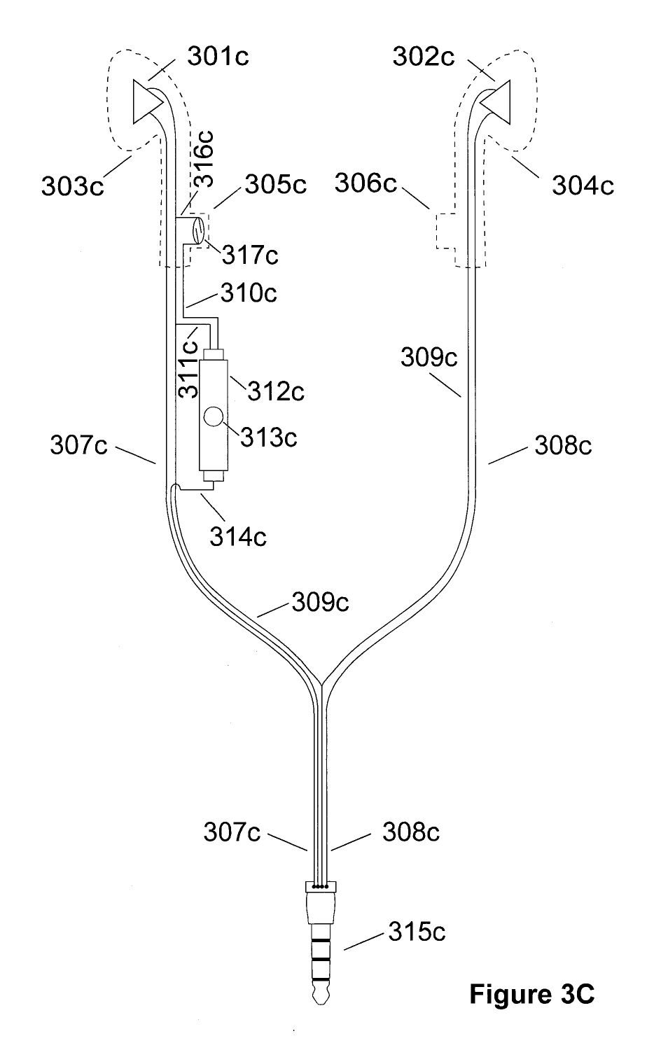

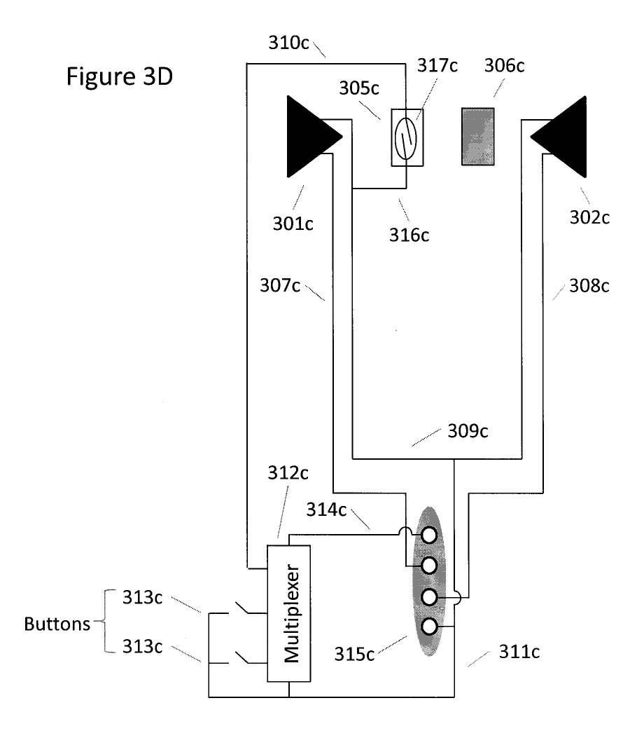

FIGS. 3A and 3B are schematic diagrams illustrating an example of a headphone system embodying aspects of the present invention. As illustrated in FIGS. 3A and 3B, in some embodiments, the headphone system may include a right coupling device 305a and a left coupling device 306a. The right coupling device 305a may be connected to a right sensor wire 310a, which may be connected to a remote control module 312a, which, in one non-limiting embodiment, may be a multiplexer, as shown in FIG. 3B. The remote control module 312a may be connected to both a ground wire 309a, via an extension wire 311a, and to a control wire 314a. Each of a right signal wire 307a, a left signal wire 308a, the ground wire 309a, and the control wire 314a may be connected to an audio plug 315a. The left coupling device 306a may be connected to the ground wire 309a via a left sensor wire 316a. The right and left coupling devices 305a and 306a may be conductive of electricity and complete/close a “Circuit A” when physically connected, effectively creating a switch. This Circuit A may connect the right sensor wire 310a, the remote control module 312a, the ground wire 309a, and the left sensor wire 316a. When this Circuit A is completed/closed, the remote control module 312a may send a signal via the control wire 314a to the plug 315a, which may be received by the audio device to which the plug 315a may be connected. Circuit A may be broken/opened when the coupling devices 305a and 306a are no longer physically connected. Breaking/opening Circuit A may cause the remote control module 312a to send a different, distinct signal via the control wire 314a to the plug 315a, which may be received by the audio device to which the plug 315a may be connected.

As illustrated in FIGS. 3A and 3B, in some embodiments, the headphone system may include a right earbud housing 303a, which encloses a right transducer 301a, and a left earbud housing 304a, which encloses a left transducer 302a. The right transducer 301a may be connected to both the ground wire 309a and the right signal wire 307a. The left transducer 302a may be connected to both the ground wire 309a and the left signal wire 308a. The remote control 312a may include a button 313a that temporarily completes a circuit when pressed and sends a signal via the control wire 314a that may be received by the audio device to which the plug 315a may be connected. In some non-limiting embodiments, the remote control module 312a may further comprise a microphone (not pictured), which may be connected to the control wire 314a and to a specific pin on the multi-pin plug 315a. In some non-limiting embodiments, the remote control module 312 may have a plurality of buttons 313a with various functions (see, e.g., FIG. 3B).

In some non-limiting embodiments, the right coupling device 305a may be at least partially enclosed within the right earbud housing 303a of the right transducer 301a, and the right coupling device 305a may be exposed through a surface (e.g., an outer surface) of the right earbud housing 303a. Similarly, in some non-limiting embodiments, the left coupling device 306a may be at least partially enclosed within the left earbud housing 304a of the left transducer 302a, and the left coupling device 306a may be exposed through a surface (e.g., an outer surface) of the left earbud housing 304a. In this way, the conductive coupling devices 305a and 306a, which may be exposed through surfaces of the housings 303a and 304a, may be physically connected to thereby close Circuit A. However, in some alternative embodiments, the coupling devices 305a and 306a may be separate from the transducers 301a and 302a and not enclosed within housings 303a and 304a.

FIGS. 3C and 3D illustrate another example of a headphone system embodying aspects of the present invention. As illustrated in FIGS. 3C and 3D, in some embodiments, the headphone system may include a right coupling device 305c. The right coupling device 305c may enclose a physical reed switch 317c, which may be open in its normal state. The physical switch 317c may be closed/activated by the proximity of a magnetic field. The physical switch 317c may be connected to both a ground wire 309c, via an extension wire 316c, and a right sensor wire 310c. The headphone system may also include a left coupling device 306c. In some non-limiting embodiments, the left coupling device 306c may be a magnet. When the left coupling device 306c is brought within sufficient proximity of the right coupling device 305c and, therefore, the physical switch 317c, the switch 317c may close/complete a “Circuit B”. This Circuit B may connect the ground wire 309c and a remote control module 312c via the extension wire 316c and the right sensor wire 310c.

When this Circuit B is completed/closed, the remote control module 312c may send a signal via the control wire 314c to the plug 315c, which may be received by the audio device to which the plug 315b may be connected. Circuit B may be broken/opened when the physical switch is opened due to the lack of a magnetic field in sufficient proximity. Breaking/opening Circuit A may cause the remote control module 312c to send a different, distinct signal via the control wire 314c to the plug 315c, which may be received by the audio device to which the plug 315c may be connected. In some non-limiting embodiments, the remote control module 312c may further comprise a microphone (not pictured), which may be connected to the control wire 314c and to a specific pin on the multi-pin plug 315c.

In some non-limiting embodiments, as illustrated in FIG. 3C, the right coupling device 305c may be at least partially enclosed within the right earbud housing 303c of the right transducer 301c. Similarly, in some non-limiting embodiments, the left coupling device 306c may be at least partially enclosed within the left earbud housing 304c of the left transducer 302c. However, in some alternative embodiments, the coupling devices 305c and 306c may be separate from the transducers 301c and 302c and not enclosed within housings 303c and 304c.

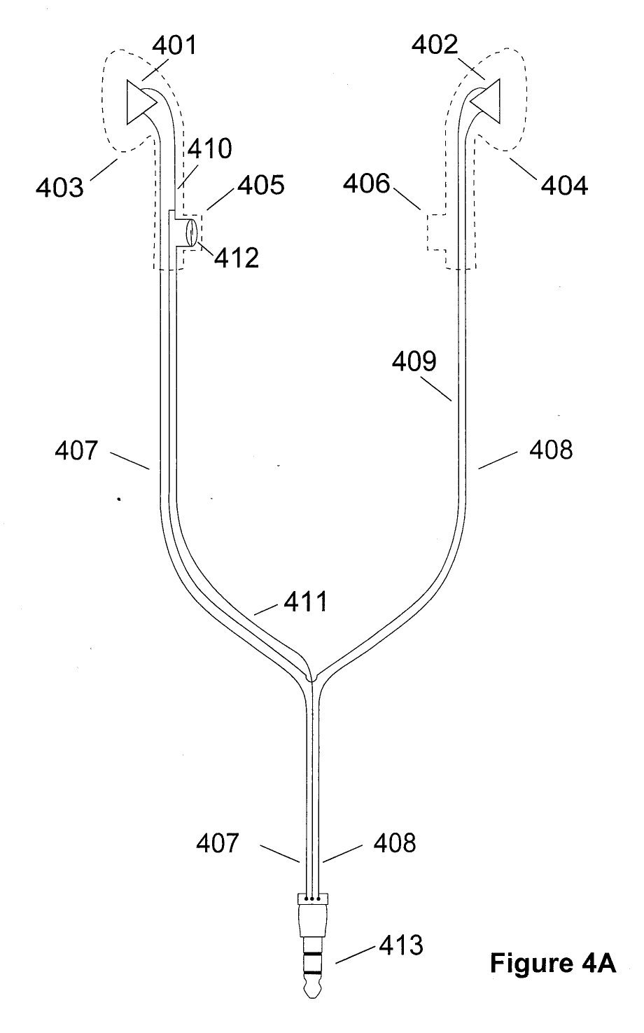

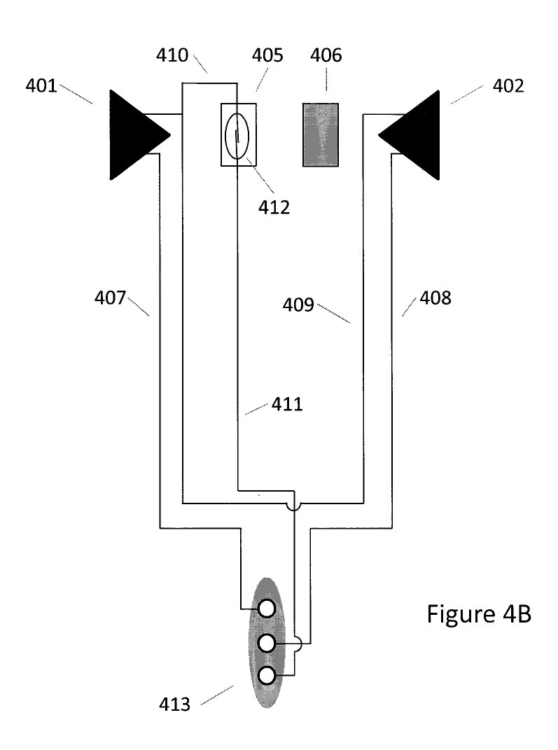

FIGS. 4A and 4B illustrate a further example of a headphone system embodying aspects of the present invention. As illustrated in FIGS. 4A and 4B, in some embodiments, the headphone system may include a right coupling device 405 that encloses a physical reed switch 412, which may be closed/complete in its normal state. The physical reed switch 412 may be opened by the proximity of a magnetic field. The physical switch 412 may be connected to both a ground wire 411 and a right extension wire 410. The right extension wire 410 may be connected to the right transducer 401 and a left extension wire 409. When the physical switch (412) is closed/complete, the right extension wire 410 and the left extension wire 409 may become connected to the ground wire 411 and complete a “Circuit C”, allowing the headphones to operate normally, emitting audio from the signal sent via the plug 413 connected to an audio device.

When the left coupling device 406 is brought within sufficient proximity of the right coupling device 405 and, therefore, the physical switch 412, the switch 412 opens/breaks and prevents any audio from being emitted from the right and left headphone transducers 401 and 402, effectively muting them.

In some non-limiting embodiments, as illustrated in FIG. 3C, the right coupling device 405 may be at least partially enclosed within the right earbud housing 403 of the right transducer 401. Similarly, in some non-limiting embodiments, the left coupling device 406 may be at least partially enclosed within the left earbud housing 404 of the left transducer 404. However, in some alternative embodiments, the coupling devices 406 and 406 may be separate from the transducers 401 and 402 and not enclosed within housings 403 and 404.

FIG. 5 illustrates an additional example of a headphone system embodying aspects of the present invention. As illustrated in FIG. 5, in some embodiments, the headphone system may include a right coupling device 505 and a left coupling device 506. The right coupling device 505 may enclose a right signal wire contact 503 and a left signal wire contact 504, as well as insulation 512 between the two. A right signal wire extension 510 may connect the right signal wire contact 503 and a right signal wire 507. A left signal wire extension 511 may connect the left signal wire contact 504 and a left signal wire 508. The left coupling device 506, which may be a magnet, may be connected to a ground wire 509 via a ground wire extension 514. The right signal wire 507 may be connected to a right transducer 501 and the ground wire 509, completing a “Circuit D”. The left signal wire 508 may be connected to a left transducer 502 and the ground wire 509, completing a “Circuit E”. In some embodiments, Circuit D may further comprise a right resistor 515, and Circuit E may comprise a left resistor 516. When the right coupling device 505 and the left coupling device 506 are not coupled (essentially an open switch), the headphones are able to operate normally, emitting audio from the signal sent via an audio plug 513 connected to an audio device.

When the left coupling device 506 is coupled to the right coupling device 505, the ground 509 may become connected to the right signal wire 507 via the right signal wire contact 503 and the right signal wire extension 510, creating a path of low resistance across the Circuit D. Additionally, the coupling of the right coupling device 505 and the left coupling device 506 the ground 509 becomes connected to the left signal wire 508 via the left signal wire contact 504, creating a path of low resistance across the Circuit E. When these two circuits (i.e., Circuits D and E) are effectively shorted in this way, the headphones no longer operate normally, and cease to emit audio, effectively muting the headphones.

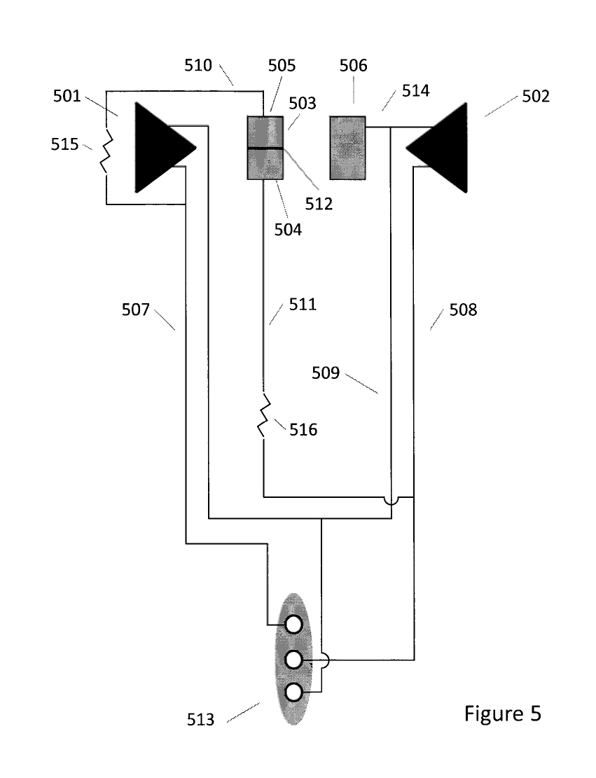

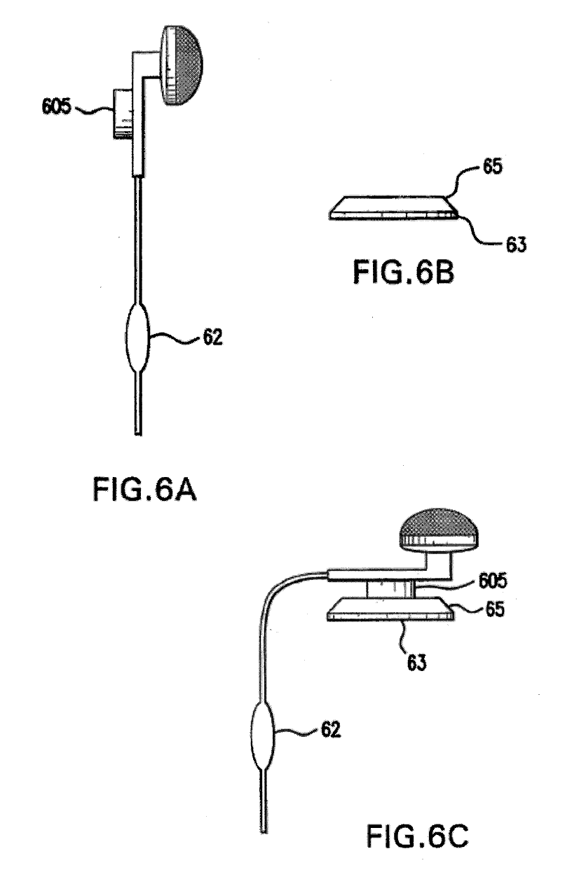

FIGS. 6A through 6C illustrate another example of a headphone system embodying aspects of the present invention. FIG. 6A illustrates a headphone transducer, which may be any of the transducers described above (e.g., right transducer 301a, 301c, 401, or 501). In some embodiments, as illustrated in FIG. 6A, the headphone transducer may be connected to a microphone 62, which may be adapted to be used with a cell phone, walkie-talkie, or the like. However, this is not required, and, in alternative embodiments, the headphone transducer does not have a microphone. In some embodiments, as illustrated in FIG. 6A, the headphone transducer may include a coupling device 605, which may be at least partially enclosed by the transducer housing. However, in alternative embodiments, the coupling device 605 may be separate from the headphone transducer. The coupling device 605 may be any of the coupling devices described above, including but not limited to coupling devices 305a, 305c, 405, and 505.

FIG. 6B illustrates an example of a coupling base 65 that may be used in embodiments of the present invention. In some embodiments, the coupling base 65 may be a magnetic coupling base that includes a magnet. In one non-limiting embodiment, the coupling base 65 may be a magnet. In another non-limiting embodiment, the coupling base 65 may be a ferrous metal, which is attracted to a magnet. In an alternative embodiment, the coupling base 65 may act as a ground in a circuit. In another non-limiting embodiment, the headphone system may include a sensor (not pictured) that detects when the first and/or second coupling devices are coupled to the coupling base. In some embodiments, the coupling base 65 may have an adhesive layer 63 (e.g., on its inner surface). The adhesive layer 63 may be capable of being permanently or removably affixed to surfaces including, for example, a dashboard of a vehicle, a desk, wall, computer monitor, telephone, portable device, etc.

In some embodiments, as illustrated in FIG. 6C, the coupling devise 605 may be removably attached to the coupling base 65. In one non-limiting example, the coupling base 65 may be secured to an object, and a user may, when wishing to temporarily stop using the headphone transducer, remove the headphone transducer from his/her ear and attach it to the coupling base 65 via coupling device 605. By bringing the coupling device 605 within close proximity to the coupling base 65, the coupling base 65 may keep the headphone transducer securely in place (e.g., through attraction of magnetic components of the coupling device 605 and coupling base 65). In some embodiments, when the user wishes to resume using the headphone transducer, the user may simply give a light tug on the headphone transducer and the coupling device 605 may become disengaged from the coupling base 65, thereby allowing the user to re-insert the headphone transducer back into his/her ear without difficulty.

In some embodiments, the headphone system may include circuitry (such as, for example, the circuitry described above with reference to FIGS. 3A-5) configured to remotely control a portable audio device, control the volume of audio produced by the first and second transducers, and/or mute the audio produced by the first and second transducers based on a change of potential across one or more wires within the circuit, wherein the change is caused by contact of the coupling device 605 (and/or another coupling device 605 of the headphones system) with the coupling base 65.

While the aforementioned examples of headphone systems implement the closing/completion or opening/breaking of one or more circuits via the temporary coupling of the two coupling devices and/or the temporary coupling of one or more coupling devices with a coupling base (essentially creating a switch), some embodiments of the present invention may use other means whereby the coupling of two coupling devices (and/or the temporary coupling of one or more coupling devices with a coupling base) can control an audio device or the audio emitted by a pair of headphones/earbuds. These alternative means may include, but are not limited to: charging or discharging of a capacitor, applying or removing resistance to an electrical circuit through a resistor, or varying the voltage and/or frequency of an electrical current. In FIGS. 4A and 4B, for example, rather than breaking/opening the circuit, the coupling of the coupling devices 405 and 406 may complete a circuit comprising a resistor, thereby adding sufficient resistance to the existing circuit (i.e., Circuit C) to effectively break it.

Another embodiment can include a physical button to be affixed to one or both coupling devices whereby it is pressed as a result of the coupling devices being temporarily coupled with each other (and/or as a result of one or more of the coupling devices being temporarily coupled with a coupling base). The pressing of the button would send a signal to a remote control module which would, in turn signal the audio player to which the earbuds/headphones are connected.

In another alternative embodiment of the present invention, the headphone system may include a system that sends a varying signal to the remote control module based on the proximity of two magnets, which are included in first and second coupling devices, respectively, and connected to each earbud/headphone. For instance, when the magnets of the first and second coupling devices are in very close proximity but not fully coupled, one signal could be sent to the control module, and, when they are in further proximity (but still sufficiently within their magnetic field), a different signal could be sent to the control module. In a non-limiting embodiment, this system could, for example, be constructed through multiple reed switches that are each set to close at increasingly strong magnetic fields.

In some embodiments, coupling of the coupling devices with each other (and/or coupling of one or more coupling devices to a coupling base) initiates a process in the control module that activates a switch or applies resistance within a circuit, effectively reprogramming it. For example, in one non-limiting embodiment, the initiated process may act to change one or more signals the remote control module may send to an audio device to which it is connected. In one, non-limiting embodiment, this signal may change from causing an audio device to mute the audio from the device, to causing the device to maintain its current audio volume. In another non-limiting embodiment, this signal may change from causing an audio device to pause, to causing the device to increase or decrease the audio volume from the device.

In some embodiments, the signals sent by the remote control module after being triggered by the coupling of coupling devices of the earbuds/headphones can have various functions depending on the device to which they are connected. In addition to the aforementioned functions such as play, pause, mute, skip forward, skip backward, or answer a call, other functions could include increasing or decreasing the audio volume from the player or headphones, starting or stopping an audio-related application on the device (such as opening a music player application, a mobile phone application, etc.), or controlling a non-audio-related application (such as a timer/stopwatch application, an application reporting the device's physical location via a GPS system, an application sending an electronic message to another device, etc.).

Moreover, in the various embodiments described herein, any suitable coupling device or devices can be employed to couple the earbuds/headphones together in accordance with the invention, including the coupling devices described in U.S. Pat. Nos. 7,436,974; 7,693,295; and 8,189,843, snaps, various clasp devices, interlocking connectors, and the like. In some embodiments, the coupling device or devices can be permanently or removably affixed to the earbuds or can be incorporated into or made a part of the construction of the earbud itself.

Also, while the term “earbuds” is used throughout this description, one of ordinary skill in the art will readily recognize that the systems described herein also can include any suitable alternative to earbuds, such as ear-clips and any other appropriate headphone type. In some embodiments that include ear-clip headphones, the ear-clip headphones may be similar to the ear-bud headphones, as the only connection between the left and right transducers is the headphone wire (unlike with traditional headphones whereby a connecting device connects the two headphones by going over the top of the head). In one non-limiting embodiment, a clip, which may be made of plastic or another suitable material, is attached to each transducer and allows the user to clip the headphone in place around the outer ear and, thereby, secure the transducer directly over the outer ear.

Additionally, while elements of embodiments of the headphone systems embodying aspects of the present invention have been described as “right” elements (e.g., a right transducer) and “left” elements (e.g., a left transducer), the elements are not limited thereto. For example, in some alternative embodiments, the elements described above as right elements may be left elements, and the elements described above as left elements may be right elements.

In some non-limiting embodiments, the signal produced by the remote control module may be dependent on the number of times and/or duration that the circuit is closed/completed or opened/broken.

Furthermore, U.S. Patent Application No. 2010/0284525 is hereby incorporated by reference in its entirety.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

What is claimed is:

1. A headphone system, comprising:
a first headphone including a first transducer;
a second headphone including a second transducer;
a first coupling device;
a second coupling device; and
circuitry configured to remotely control a portable audio device, control the volume of audio produced by the first and second transducers, and/or mute the audio produced by the first and second transducers based on coupling of the first and second coupling devices with each other.

2. The system of claim 1, wherein the first and second coupling devices are conductive of electricity, and the circuitry includes a circuit that is completed by the physical connection of first and second coupling devices.

3. The system of claim 2, wherein the first headphone includes a first housing, the second headphone includes a second housing, the conductive first coupling device is exposed through a surface of the first housing, and the conductive second coupling device is exposed through a surface of the second housing.

4. The system of claim 1, wherein the first coupling device includes a physical switch, and the circuitry includes a circuit that is completed via the opening or closing of the physical switch.

5. The system of claim 4, wherein the physical switch is opened or closed by the presence of a magnetic field.

6. The system of claim 4, wherein the second coupling device includes a magnet.

7. The system of claim 1, wherein the circuitry includes a circuit that, when completed, effectively shorts another circuit or applies resistance across another circuit.

8. The system of claim 1, wherein the first headphone is a first earbud, and the second headphone is a second earbud.

9. The system of claim 1, wherein the first headphone is a right headphone, the second headphone is a left headphone, the first coupling device is a right coupling device, and the second coupling device is a left coupling device.

10. The system of claim 1, wherein the first headphone includes the first coupling device, and the second headphone includes the second coupling device.

11. The system of claim 1, wherein the circuitry includes:
a multi-pin audio plug; and
a ground wire and first and second signal wires connected to respective pins of the multi-pin audio plug.

12. The system of claim 11, wherein the circuitry includes:
a remote control module having one or more buttons; and
a control wire connected to the remote control module and a pin of the multi-pin audio plug.

13. The system of claim 12, wherein the circuitry includes:
a first sensor wire connected to the remote control module and the first coupling device; and
a second sensor wire connected to the second coupling device and the ground wire.

14. The system of claim 12, wherein the circuitry includes:
a first sensor wire connected to the remote control module and the first coupling device; and
an extension wire connected to the first coupling device and the first signal wire.

15. The system of claim 11, wherein the ground wire is connected to the first coupling device, and the circuitry includes:
a first extension wire connected to the first coupling device and the first transducer; and
a second extension wire connected to the first extension wire and the second transducer.

16. The system of claim 11, wherein the first coupling device includes first and second signal wire contacts and insulation separating the first and second signal wire contacts, and the circuitry includes:
a first signal wire extension connecting the first signal wire and the first signal wire contact;
a second signal wire extension connecting the second signal wire and the second signal wire contact; and
a ground wire extension connecting the second coupling device and the ground wire.

17. The system of claim 16, wherein the first signal wire extension includes a first resistor, the second signal wire extension includes a second resistor.

18. The system of claim 1, further comprising a control module configured to enable a user to remotely control a portable audio device or to change the state of the circuitry, wherein the coupling of the first and second coupling devices initiates a process in the control module that activates a switch or applies resistance within a circuit.

19. The system of claim 1, further comprising:
a control module; and
a coupling base,
wherein coupling of the first and/or second coupling device to the coupling base initiates a process in the control module that activates a switch or applies resistance within a circuit.

20. A headphone system, comprising:
a first headphone including a first transducer;
a second headphone including a second transducer;
a first coupling device;
a second coupling device;
a coupling base; and
circuitry configured to remotely control a portable audio device, control the volume of audio produced by the first and second transducers, and/or mute the audio produced by the first and second transducers based on contact of the first and/or second coupling devices with the coupling base.
